(19) United States
(12) Patent Application Publication
(10) Pub. No.: US 2005/0271882 A1
(43) Pub. Date: Dec. 8, 2005

(54) Coating composition for plastic substrates

(76) Inventors: Ingrid Frieda Martha Walther, Ostfildern (DE); Lavonne Swift, Detroit, MI (US); Latoska Price, Southfield, MI (US)

Correspondence Address: Michelle J. Burke;Akzo Nobel Inc., 7 Livingstone Avenue, Dobbs Ferry, NY, 10522-3408, US

(21) Appl. No.: 11/144,584

(22) Filed: Jun. 3, 2005

Related U.S. Application Data
(60) Provisional application No. 60/577,307, filed on Jun. 5, 2004.

(51) Int. Cl. B05D 3/02; B05D 7/00; B32B 27/00

(52) U.S. Cl. 428/423.1; 427/372.2; 427/402

(57) ABSTRACT

A coating composition for coating plastic substrates is disclosed which comprises at least one hydroxyl-functional film forming polymer, at least one polyisocyanate compound; and a novel adhesion promoter additive. The adhesion promoter additive comprises (A) at least one modified polyolefin; and (B) at least one component selected from the group consisting of monohydric alcohols, epoxy functional silanes, and mixtures thereof. The invention also relates to coated plastic substrates and method of coating such substrates.

### CROSS REFERENCE TO RELATED APPLICATIONS

This application claims priority from U.S. provisional application Ser. No. 60/577,307, filed on Jun. 4, 2004.

### SUMMARY OF THE INVENTION

The present invention relates to a coating composition suitable for use with a variety of plastic components, including thermoplastic polyolefin (TPO). The coating composition comprises an adhesion promoter additive having (a) at least one modified polyolefin and (b) at least one monohydric alcohol, at least one epoxy-functional silane, or a mixure thereof. Substrates painted with the coating composition are also disclosed. The composition of the present invention is particularly useful as a primer for plastic components in the automotive industry.

### BACKGROUND OF THE INVENTION

Plastics are used in wide variety of applications, including containers, household appliances, automobile parts and accessories, and other commercial items. With respect to the automotive industry, the use of plastic components has increased dramatically over the past several decades. The quest for lighter, more fuel efficient cars has led automotive manufacturers to utilize plastics in an increasing number of interior and exterior applications, such as airbag covers, bumpers, fascias, fenders, door panels, panel hoods, panel roofs, and panel trunk lids. Besides generally being low cost, plastics are also low weight, corrosion resistant, impact resistant, relatively easy to mold, and recyclable. Because of these and other advantages derived from their use, it is inevitable that more and more automotive parts will be produced from plastics.

It is often desirable to paint or otherwise coat automotive components, especially those of the exterior body, in order to decorate them or protect them from degradation in the face of sunlight, moisture, heat and cold. To achieve longer lasting and more durable parts, it is important for these coatings to be tightly adhered to the surface of the components.

One of the problems with the increasing use of plastic for automotive components is that polymeric substrates made from a variety of thermoplastic and thermosetting materials can have widely varying surface properties, such as surface tension, roughness, and flexibility, which can make strong adhesion of coatings difficult, particularly after aging or environmental exposure. Typically, in order to use a polyurethane primer on a plastic during automotive repair, the plastic must first be identified. (i.e., type, flexibility, etc.) by performing such activities as the “burn” test or by checking identification system in order to determine the appropriate process for coating the plastic.

Thermoplastic olefin (TPO), an alloy of polypropylene and an elastomer, is one type of plastic commonly used in the automotive industry. The structure of this polymer results in a surface that most coatings will not wet out or adhere to. Therefore, the surface must be physically or chemically altered in order to for it to be coated with most currently available coating technology, but each of these surface pretreatments has its own disadvantages. Plasma treatment or corona discharge employs ionized gases to oxidize the surface and can be difficult and costly. Flame treatment also oxidizes the surface but requires a precise distance of flame that is difficult to achieve on a production line. Etching is another way of preparing the surface. However, the etching chemicals can be toxic or the subject of environmental concerns.

Another, more common approach is painting a thin layer or “tie coat” of an adhesion promoting primer containing a chlorinated polyolefin resin (CPO) onto the surface to gain adhesion. However, these solvent borne chlorinated polyolefins may have limited solubility and require use of aromatic solvents such as xylene or toluene, which may be difficult to utilize without exceeding federal and state emissions standards. Further, this multi-step process can be time consuming, more costly and is prone to omission. Therefore, it is desired to shorten this process by developing an additive that would provide the properties of adhesion to plastics, including TPO, so that both the need for a “tiecoat” and identifying the plastic, prior to coating, would be unnecessary steps. Such a process would be highly beneficial in the automotive industry and the automotive repair industry as well as other industries in which plastics are commonly used.

Some coating compositions that exhibit acceptable adhesion directly to polymeric materials, such as TPO, without the use of separate adhesion promoter layers or tie coats have been developed. For example, polyolefin diols have been used in coating compositions to improve adhesion to polymeric substrates without the use of separate adhesion promoter layers or tie coats. For example, U.S. Pat. No. 6,001,469, herein incorporated by reference, discloses a coating composition containing a saturated polyhydroxylated polydiene polymer having terminal hydroxyl groups.

U.S. Pat. No. 4,863,988, also incorporated by reference herein, relates to a curable paint composition containing a curable film-forming resin and a chlorinated and graft-modified polypropylene.

However, there remains a need for a coating composition, incorporating an adhesion promoter additive therein, which has good adhesion directly to the surface of a wide variety of plastics.

### SUMMARY OF THE INVENTION

It is an object of the present invention to provide an adhesion promoter additive that enhances the adhesion properties of a coating formulation, particularly with respect to plastic substrates.

It is a related object of the invention to provide a coating composition that will directly adhere to the surface of a plastic substrate without the need to first apply a tie coat to the substrate.

It is a further object of the invention to provide a coating composition that will form a film coating on a variety of plastic substrates without the need to identify the particular plastic substrate prior to applying the coating.

It has been discovered that when a modified polyolefin is combined with a monohydric alcohol or an epoxy-functional silane, a novel adhesion promoter additive is formed that can be incorporated into a coating composition thereby allowing the composition to be coated directly onto many kinds of plastic substrates without the use of conventional pretreatment methods. An additional advantage was also discovered in that the additive also lessens the need to flexibilize the coating composition.

More particularly, the present invention relates to an adhesion promoter additive comprising: (A) at least one modified olefin; and (B) at least one component selected from the group consisting of monohydric alcohols, epoxy functional silanes, and mixtures thereof.

The invention also relates to coating compositions comprising the adhesion promoter additive. One such coating composition comprises at least one hydroxyl-functional film forming polymer and at least one polyisocyanate compound as well as the adhesion promoter additive.

The invention also relates to a method of coating a plastic substrate by applying a coating composition comprising the adhesion promoter additive onto a plastic substrate and curing the coating composition and to plastic articles coating with such a coating composition.

Although particularly advantageous in the automotive industry, the present invention is also applicable to other industries, as suggested above, which utilize plastic substrates.

### DETAILED DESCRIPTION OF THE INVENTION

Other than where otherwise specified, all numbers expressing quantities of ingredients, reaction conditions, and so forth used in the specification and claims are to be understood as being modified in all instances by the term “about”.

The current invention relates to a coating composition comprising at least one hydroxyl-functional film forming polymer, at least one polyisocyanate compound, and an adhesion promoter additive. The adhesion promoter additive comprises (A) at least one modified olefin; and (B) at least one component selected from the group consisting of monohydric alcohols, epoxy functional silanes, and mixtures thereof. Preferably, the amount of the adhesion promoter additive incorporated into the coating composition is between about 20% to 40% by volume, preferable 25% to 35%.

The hydroxyl-functional film forming polymer preferably has a hydroxyl value between 50 and 300 mg KOH/g based on total polymer and more preferably between 70 and 200 mg KOH/g. The number average molecular weight is preferably less than or equal to 6000 and more preferably less than or equal to 4500. The polydispersity is preferably between about 1.1 to about 5 and more preferably between about 1.1 and about 3. The acid value of the polymer is preferably less than or equal to 50 mg KOH/g based on total solids.

Examples of suitable hydroxyl-functional film forming polymers include polyesters, polyacrylates, polyvinyl, polyurethanes, polycarbonates or polyamides. In one preferred embodiment, the polymer is an polyacrylate polyol.

The polyisocyanate compound is a polyisocyanate having two or more, preferably two to four isocyanate groups. Examples of useful polyisocyanate compounds include toluene diisocyanate, methylene bis(4-cyclohexylisocyanate), isophorome diisocyanate and its isocyanurate or adducts, hexamethylene diisocyanate and its iscoyanurate, biuret, uretdione, and allophanate, and meta-tetramethylxylene diisocyanate and the adduct thereof with trimethylolpropane.

The present coating composition further comprises an adhesion promoter additive that comprises at least one modified polyolefin. Preferably, the amount of modified polyolefin in the additive is between 10% by weight and 30% by weight, based on the weight of the additive. One particularly preferred modified polyolefin is chlorinated polyolefin, also known as CPO. Chlorinated polyolefins suitable for use in the present invention preferably have a chlorine content between 15% by weight and 60% by weight, based on the total solid weight of the final chlorinated polyolefin, and more preferably between 18% by weight and 23% by weight. The chlorinated polyolefin preferably has a weight average molecular weight between 5000 and 200000, more preferably, between 10000 and 40000. The chlorinated polyolefin may be solid, in powder or pelletized form, or in solution. Generally, any chlorinated polyolefin known to those skilled in the art to be an adhesion promoter may be used, such as, for example, chlorinated polypropylene, chlorinated polybutene, chlorinated polyethylene, and mixtures thereof. One suitable chlorinated polyolefins is CPO-343-1, available commercially from Eastman Chemical Company of Kingsport, Tenn., USA. Other suitable chlorinated polyolefins are described in U.S. Pat. Nos. 4,997,882; 5,319,032; and 5,397,602, herein incorporated by reference.

Other suitable modified polyolefins include, for example, AP 440-1, a non-chlorinated polyolefin available commercially from Eastman Chemical Company of Kingsport, Tenn., USA. More generally, if non-chlorinated, the modified polyolefin must have sufficient solubility for inclusion into a primer formulation, a low film formation temperature, and a high level of acid functionalization (acid number≧40). Preferably, the modified polyolefin is capable of being heat cured.

The adhesion promoter also comprises at least one component selected from the group consisting of monohydric alcohols, epoxy-functional silanes, and mixtures thereof. The term “monohydric alcohol” is used throughout the specification to describe a linear or branch-chained hydrocarbon having a single hydroxyl group located at one terminus of the molecule. Preferably, the amount of monohydric alcohol or epoxy-functional silane is present is from 5% by weight to 30% by weight of the additive. Monohydric alcohols useful in the invention contain between 8 to 18 carbon atoms, and preferably 12 to 18 carbon atoms. Examples of useful monohydric alcohols include cetylalcohol, tridecyl alcohol, tetradecyl alcohol, pentadecanol, hexadecanol, heptadecanol, and octadecanol, more preferably dodecylalcohol. Numerous additional monohydric alcohols may be used in the present invention.

Examples of suitable epoxy-functional silanes include but are not limited to (3-glycidoxypropyl) trimethoxysilane, (3-glycidoxypropyl) triethoxysilane, (3-glycidoxypropyl) tripropoxysilane, (3-glycidoxypropyl) dimethoxymethylsilane, (3-glycidoxypropyl) dimethylmethoxysilane. Other epoxy-functional silanes are known in the literature and are obtainable by procedures recognized in the art.

Optionally, the coating composition of the present invention can also contain one or more dyes or pigments to provide color and/or hiding. Any conventional pigment known to those skilled in the art may be utilized, including inorganic pigments such as titanium dioxide, talc, mica, iron oxides, lead oxides, chrominum oxides, lead chromate and carbon black/conductive carbon black, and organic pigments such as phthalocyanine blue and phthalocyanine green, as well as a variety of other color pigments. Preferably, the total amount of pigment in the coating composition will be between 15% by weight and 60% by weight, based on total solids. The specific amount of pigment may vary, but generally, the amount of pigment is such that requisite hiding is achieved at the desired film thickness and application solids.

In one embodiment of the current invention, the coating composition further comprises a flexibilizer to impart additional elasticity to the dried film and help prevent cracking of the film. The flexibilizer may be a polyester, a soft acrylic resin having a glass transition temperature below about 10° C., or preferably, a monofunctional alkane. Examples of suitable monofunctional alkanes include those having an alkyl chain of C₈-C₁₈ of functionality X, where X can be OH, NH or SH. Particularly preferred are C₁₂-C₁₈ compounds with OH functionality such as dodecylalcohol, tridecylalcohol, tetradecylalcohol, pentadecanol, hexadecanol, heptadecanol and octadecanol. In one embodiment, the flexibilizer may be the the same as the monohydric alcohol utilized in the adhesion promoter additive.

The present coating composition may, in addition to any solvents provided by other coating components, further include a solvent component. Non-limiting examples of suitable solvents include aliphatic solvents; aromatic and/or alkylated aromatic solvents such as toluene, xylene, and hydrocarbon solvents; alcohols such as isopropanol; esters; ketones glycol ethers; and glycol ether esters.

If desired, the coating composition of the present invention can contain other materials well known in the art of formulating surface coatings, such as, for example, surfactants, flow control agents, thixotropic agents, fillers, anti-gassing agents, organic co-solvents, additional film-forming polymers, polymeric microparticles, catalysts and other conventional additives.

The coating composition of the present invention may be made using techniques well known to those skilled in the art. The percent by weight solids content of the coating composition preferably varies from 19% to 73%.

The coating composition of the present invention is particularly suited for the coating of plastic substrates, including but not limited to thermoplastic olefins, polycarbonates, polyesters, polypropylene, polyurethanes and polyamides, nylon, ABS (acrylonitrile butadiene styrene), SMC (sheet molding compound), RIM (reaction injection molding) urethane, and combinations thereof.

The present coating composition may be applied to the substrate by any conventional means including brushing, dipping, flow coating, spraying and the like but is most often is applied by spraying. Conventionally known techniques and equipment for manual or automatic spraying and electrostatic spraying can be used. Although conventional application means are employed, one of the advantages of the present coating composition is that it can be deposited directly onto the surface of a plastic substrate without the need of a separate adhesion promoter, tie coat layer or corona pretreatment.

When the coating composition is used as a primer composition, subsequent topcoats such as conventional base coat-clear coat composites or conventional monocoat top coats can be applied to the primer coating. Still further, when used as a primer or an adhesion promoter layer, the coating composition can be air flashed subsequent application of top coat layer(s) or, alternatively, can be pre-baked to a cured film prior to top coat application.

Although one preferred embodiment of a coating composition has been described herein, the novel adhesion promoter additive of the present invention may be utilized as an additive in any conventional primer composition, preferably in primer compositions comprising isocyanates. It has been found that use of the adhesion promoter additive in primer compositions provides primers having good adhesion, not only to plastic substrates but also to metal substrates, particularly steel.

The present invention may be further illustrated by the following non-limiting examples. All parts and percentages therein are by weight unless otherwise indicated or understood.

### EXAMPLES

For the following examples, adhesion promoter additives according to the present invention were prepared. One adhesion promoter additive (“APA-1”) was prepared by adding, in order, 30 parts by weight dodecylalcohol, 20 parts by weight CP 343-1, a chlorinated polyeolefin adhesion promoter (e.g. 25 wt % CPO in xylene) available commercially from Eastman Chemicals Company, and 50 parts by weight xylene to a suitable vessel and mixing under low agitation for 15 minutes. A second adhesion promoter additive (“APA-2”) was prepared by adding, in order, 20 parts by weight of CP-440-1, a non-chlorinated polyeolefin adhesion promoter (e.g. 25 wt % CPO in xylene) available commercially from Eastman Chemicals Company, 75 parts by weight xylene, and 5 parts by weight of (3-glycidoxypropyl) trimethoxysilane to a suitable vessel and mixing under low agitation for 15 minutes.

Two control systems were utilized in examples 1 and 2 for comparison purposes. Control system A is Primer PO, a CPO tiecoat composition commercially available from Akzo Nobel Coatings Inc. of Norcross, Ga., USA. Control system B is Plastoflex, a primer composition, also available commercially from Akzo Nobel Coatings Inc.

The plastic panel substrates used in the following examples are Hifax CA186AC, a thermoplastic olefin (TPO) available commercially from Basell Polyolefins of Elkton, Md., USA; Xenoy 1102, a polycarbonate (PC)/polybutylene terephthalate (PBT) blend available commercially from General Electric Plastics of Pittsfield, Mass., USA, and Phase Alpha Sheet Molding Compound (SMC) available commercially from Ashland Chemical Company in Dublin, Ohio.

### Example 1

A coating composition was prepared by adding, in order, 100 parts by volume of Colorbuild Primer, available commercially from Akzo Nobel Coatings Inc, 50 parts by volume of Colorbuild Sealer Hardener, also available commercially from Akzo Nobel Coatings, and 30 parts by volume of APA-1. These components were mixed together until homogenous and having a viscosity of 15-18 seconds on a #4Din cup. This coating composition was then spray applied, separately, with a HPLV spray gun to each of the plastic panel substrates. The applied coating was allowed to flash for 15 minutes. Next, Autobase Plus, a basecoat commercially available from Akzo Nobel Coatings Inc, was activated according the technical method required for use on plastic and then spray applied to each of the primed panels to hiding as denoted by coverage using black and white hiding sticker. The applied basecoat was allowed to flash for 15 minutes until dry to a finger touch. Finally, Autoclear III, a clearcoat commercially available from Akzo Nobel Coatings Inc., was activated per the technical data sheet for coating on plastics then spray applied to each of the basecoats. These samples are hereto referred as Sample A.

Control A was supplied ready to spray and was applied to the plastic panel substrates and was flashed for 15 minutes. Control B was applied to the substrates as directed on the technical data sheet supplied with Control B and allowed to flash for 15 minutes. After flashing, Autobase Plus basecoat and Autoclear III clearcoat were applied as set forth above to all of the Control A and Control B panels.

Mandrel bend testing pursuant to General Motors Method 9503P at ambient temperature (0.5 inch mandrel) for the flexible TPO and crosshatch adhesion testing pursuant to General Motors method 9071P were conducted on the substrates. As can be seen in Table 1 below, the panels of Sample A performed equally well to the panels of Control A and Control B.

TABLE 1

| | | | | Mandrel Bend Rating |
|---|---|---|---|---|
| | Adhesion (10 = best) | | | (10 = best) |
| | Initial | | | (Ambient Temperature) |
| System | TPO | SMC | PC/PBT | TPO |
| Sample A | 10 | 10 | 10 | 10 |
| Control A | 10 | NA | NA | 9 |
| Control B | N/A | 10 | 10 | NA |

### Example 2

A coating composition was prepared by adding 33 parts by weight of a polyester polyol with T_{g} less than 20° C. to 67 parts by weight of Colorbuild Primer and mixed with a spatula to form a modified Colorbuild Primer. 50 parts by volume of Colorbuild Sealer Hardener and 30 parts by volume of APA-2 were added to 100 parts by volume of the modified Colorbuild Primer. These components were mixed together until homogenous and having a viscosity of 15-18 seconds on a #4Din cup. This coating composition was then spray applied, separately, with a HPLV spray gun to each of the plastic panel substrates. The applied coating was allowed to flash for 15 minutes. Next, Autobase Plus was activated according the technical method required for use on plastic and then spray applied to each of the primed panels to hiding as denoted by coverage using black and white hiding sticker. The applied basecoat was allowed to flash for 15 minutes until dry to a finger touch. Finally, Autoclear III was activated per the technical data sheet for coating on plastics then spray applied to each of the basecoats. These samples are hereto referred as Sample B.

Control A was supplied ready to spray and was applied to the plastic panel substrates and was flashed for 15 minutes. Control B was applied to the substrates as directed on the technical data sheet supplied with Control B and allowed to flash for 15 minutes. After flashing, Autobase Plus basecoat and Autoclear III clearcoat were applied as set forth above to all of the Control A and Control B panels.

All panels were allowed to age for seven days at ambient temperature. Mandrel bend testing pursuant to General Motors Method 9503P at ambient temperature (0.5 inch mandrel) for the flexible TPO and crosshatch adhesion testing pursuant to General Motors method 9071P were conducted on the substrates. As can be seen in Table 2, the panels of Sample B performed equally to the panels of Control A and Control B.

TABLE 2

| | | | | Mandrel Bend Rating |
|---|---|---|---|---|
| | Adhesion (10 = best) | | | (10 = best) |
| | Initial | | | (Ambient Temperature) |
| System | TPO | SMC | PC/PBT | TPO |
| Sample B | 10 | 10 | 10 | 10 |
| Control A | 10 | NA | NA | 9 |
| Control B | N/A | 10 | 10 | NA |

### Example 3

Humidity resistance testing according to General Motors Method 4465P and chip resistance testing according to General Motors Method 9508 were performed on the TPO panels prepared as for Sample A above. All panels were allowed to age for seven days at ambient temperature. Mandrel Bend testing according to General Motors Method 9503P at both ambient temperature and at −20° F. was also conducted on the panels. As can be seen in Table 3 below, the coating comprising APA-1 (Sample A) had good retention and chip resistance.

TABLE 3

| | Mandrel Bend | | % Paint Retention | Chip Resistance |
|---|---|---|---|---|
| System | RT | −20° F. | 96 hours humidity | Rating |
| Sample A | 10 | 4 | 100% | GM9 |

### Example 4

Humidity resistance testing according to General Motors Method 4465P and chip resistance testing according to General Motors Method 9508 were performed on SMC and PC/PBT panels prepared as for Sample A and Sample B above. All panels were allowed to age for seven days at ambient temperature. The results are shown in Table 4 below. Note that all paint removal after humidity occurred between the base coat and the primer. No failure to the substrates was observed.

TABLE 4

| | |
|---|---|
| % Paint Remaining | |
| (96 hours humidity) | Chip Resistance Rating |

| System | SMC | PC/PBT | SMC | PC/PBT |
|---|---|---|---|---|
| Sample A | 75 | 35 | GM9 | GM9 |
| Sample B | 75 | 35 | GM9 | GM9 |

### Example 5

In this example, a coating composition of the present invention was compared to currently available plastic primers. The plastic panel substrates used in this example are Hifax CA186AC, a thermoplastic olefin (TP0) available commercially from Basell Polyolefins of Elkton, Md., USA and Cyclolac AR4051, an acrylonitrile butadiene styrene (ABS) available commercially from General Electric Plastics of Pittsfield, Mass., USA,

A coating composition was prepared using APA-1 as for Example 1 above. This composition is hereto referred as Sample D. Sample D was compared against SUA 4903 and DPX 801, two primers available commercially from PPG Industries, and UPO7226, a primer available commercially from The Sherwin-Williams Company.

Sample D was spray applied, separately, with a HPLV spray gun to the plastic panel substrates. The applied coating was allowed to flash for 15 minutes. Next, Autobase Plus was activated according the technical method required for use on plastic to hiding as denoted by coverage using black and white hiding sticker. The applied basecoat was allowed to flash for 15 minutes until dry to a finger touch. Finally, Autoclear III was activated per the technical data sheet for coating on plastics then spray applied to each of the basecoats.

The comparative primers were applied to the substrates as directed on the technical data sheets supplied with the products. Autobase Plus basecoat and Autoclear III clearcoat were then applied as set forth above to all of the substrates coated with the comparative primers.

Mandrel bend testing pursuant to General Motors Method 9503P at ambient temperature, relative humidity pursuant to General Motors method 4465P, chip resistance pursuant to General Motors method 9508P (using Gravelometer), and initial adhesion testing pursuant to General Motors method 9071P were conducted on each of the coated substrates. The results are shown in Table 5 below.

TABLE 5

| | | 96 hours Humidity resistance test | | | | | | | | | |
|---|---|---|---|---|---|---|---|---|---|---|---|
| | | | | | | Adhesion, | | | | | |
| | | Initial | | Adhesion | | 2 hr | | | | Flexibility | |
| | Sub- | adhesion | | after 96 hr | | recovery | | Gravelometer | | Mandrel | |
| Primer | strate | X | # | X | # | X | # | RT | Cold | RT | Cold |
| Sample D | ABS | 100 | 100 | 100 | 96 | 100 | 99 | 9 | 9 | | |
| | TPO | 100 | 100 | 100 | 85 | 100 | 100 | 9 | 9 | 9 | 10 |
| PPG | ABS | 100 | 100 | 100 | 84 | 98 | 100 | 9 | 9 | | |
| SUA4903 | TPO | 100 | 100 | 99 | 0 | 100 | 70 | 9 | 9 | 8 | 9 |
| PPG | ABS | 100 | 100 | 99 | 43 | 100 | 99 | 9 | 9 | | |
| DPX801 | TPO | 100 | 100 | 99 | 30 | 100 | 99 | 9 | 9 | 6 | 6 |
| S-W | ABS | 100 | 100 | 100 | 55 | 100 | 95 | 9 | 9 | | |
| UPO7226 | TPO | 100 | 100 | 100 | 88 | 100 | 100 | 9 | 9 | 6 | 4 |

X: Crosscut, #: Crosshatch. Both reflect % adhesion retention

The present invention has been described in detail, including the preferred embodiments thereof. However, it will be appreciated that those skilled in the art, upon consideration of the present disclosure, may make modifications and/or improvements on this invention still within the scope and spirit of this invention as set forth in the following claims.

1. A coating composition comprising
at least one hydroxyl-functional film forming polymer;
at least one polyisocyanate compound; and
an adhesion promoter additive;
wherein the adhesion promoter additive comprises (A) at least one modified polyolefin; and (B) at least one component selected from the group consisting of monohydric alcohols, epoxy functional silanes, and mixtures thereof.

2. The composition according to claim 1 wherein the amount of modified polyolefin present in the additive is between about 10% by weight and about 30% by weight based on total weight of the additive.

3. The composition according to claim 2 wherein the amount of modified polyolefin in the additive is between about 20% by weight and about 30% by weight.

4. The composition according to claim 1 wherein the modified polyolefin is a chlorinated polyolefin.

5. The composition according to claim 4 wherein the chlorinated polyolefin is selected from the group consisting of chlorinated polyethylene, chlorinated polypropylene, chlorinated polyethylene/polypropylene copolymers and mixtures thereof.

6. The composition according to claim 1 wherein the modified polyolefin is a non-chlorinated polyolefin.

7. The composition according to claim 1 wherein the amount of monohydric alcohol or epoxy-functional silane in the adhesion promoter additive is from about 5% by weight to about 30% by weight, based on total weight of the additive.

8. The composition according to claim 1 wherein the adhesion promoter additive comprises a monohydric alcohol.

9. The composition according to claim 8 wherein the monohydric alcohol is selected from the group consisting of cetylalcohol, tridecyl alcohol, tetradecyl alcohol, pentadecanol, hexadecanol, heptadecanol, and octadecanol, dodecylalcohol, and mixtures thereof.

10. The composition according to claim 1 wherein the adhesion promoter additive comprises an epoxy-functional silane.

11. The composition according to claim 1 further comprising a flexibilizer.

12. The composition according to claim 11 wherein the flexibilizer is a monofunctional alkane, a polyester, or an acrylic resin having a glass transition temperature less than about 10° C.

13. The composition of claim 12 wherein the flexibilizer is a monofunctional alkanel.

14. The composition according to claim 13 wherein the monofunctional alkanel has an alkyl chain of C₁₂-C₁₈ of hydroxyl functionality.

15. The composition according to claim 1 further comprising a pigment.

16. The composition according to claim 1 wherein the composition is a primer composition.

17. An adhesion promoter additive comprising
at least one modified olefin; and
at least one component selected from the group consisting of monohydric alcohols, epoxy functional silanes, and mixtures thereof.

18. The additive according to claim 17 wherein the amount of modified polyolefin in the additive is between about 10% by weight and about 30% by weight based on total weight of the additive.

19. The additive according to claim 18 wherein the amount of modified polyolefin in the additive is between about 20% by weight and about 30% by weight.

20. The additive according to claim 17 wherein the polyolefin is a chlorinated polyolefin.

21. The additive according to claim 20 wherein the chlorinated polyolefin is selected from the group consisting of chlorinated polyethylene, chlorinated polypropylene, chlorinated polyethylene/polypropylene copolymers or mixtures thereof.

22. The additive according to claim 17 wherein the polyolefin is a non-chlorinated polyolefin.

23. The additive according to claim 17 comprising a monohydric alcohol.

24. The additive according to claim 23 wherein the monohydric alcohol is selected from the group consisting of cetylalcohol, tridecyl alcohol, tetradecyl alcohol, pentadecanol, hexadecanol, heptadecanol, and octadecanol, dodecylalcohol, and mixtures thereof.

25. The additive according to claim 17 comprising an epoxy functional silane.

26. A coating composition comprising the additive according to claim 17.

27. The coating composition of claim 26 further comprising at least one polyisocyanate compound.

28. A method of coating a plastic substrate comprising
applying a coating composition according to claim 1 to a plastic substrate; and
curing the coating composition.

29. A method according to claim 28 wherein the plastic substrate has not been pretreated to improve adhesion of the coating.

30. A method of coating a plastic substrate comprising applying a composition according to claim 1 on the plastic substrate to form a first coating layer and curing the first coating layer, applying a base coat composition on top of the first coating layer to form a second coating layer and curing the second coating layer; and applying a clear coat composition on top of the second coating layer to form a third coating layer and curing the third coating layer.

31. The method according to claim 28 wherein the plastic substrate is an automotive component.

32. The method according to claim 28 wherein the substrate is selected from the group consisting of thermoplastic olefins, polycarbonates, polyesters, polypropylene, polyurethanes and polyamides, nylon, acrylonitrile butadiene styrene, SMC (sheet molding compound), RIM-urethane and mixtures thereof.

33. The method according to claim 32 wherein the plastic substrate is a thermoplastic olefin.

34. A plastic substrate coated according to the method of claim 28.

35. A coating composition comprising
at least one hydroxyl-functional film forming polymer;
at least one polyisocyanate compound; and
an adhesion promoter additive;
wherein the adhesion promoter additive comprises at least one chlorinated polyolefin and at least one monohydric alcohol.
